(19) United States
(12) Patent Application Publication
(10) Pub. No.: US 2022/0058987 A1
(43) Pub. Date: Feb. 24, 2022

(54) Method and Tool to Indicate the Location of Hazards at Job Sites

(71) Applicant: Sheri Lally, Itasca, IL (US)

(72) Inventor: Sheri Lally, Itasca, IL (US)

(21) Appl. No.: 16/996,387

(22) Filed: Aug. 18, 2020

(51) Int. Cl. G09F 7/18

(52) U.S. Cl. CPC G09F 7/18; G09F 2007/1839; G09F 2007/1891

(57) ABSTRACT

Systems and methods are disclosed herein for a device and a method allowing a quick connect elevated sign attachment device, which allows a technician to affix without the use of a ladder in most instances with the use of a reacher tool. This device can be used to mark the locations of important or noteworthy services or hazards at a construction site, like a sprinkler head. The core components of the invention are a layered, flexible stainless steel bistable spring bands sealed within a reflective plastic cover, which, generally speaking, are configured as follows: 5½-inch-long steel bands with one hole at end allowing for a connection chain. The chain is separately attached to a banner, indicator or safety color banner. In order to carry out the method the core steps include technician, standing on the ground and using a reachers tool, extension arm gripper, pinches the unit with the chained banner side facing down and in a slap motion attaches the reflective band onto a pipe in the exposed ceiling. Ultimately, at the conclusion of these steps, a marker has an aerial attachment, regardless of the direction of the pipe, that can be viewed from a distance away from the location, since the banner hangs suspended from a chain. the purpose is used for indicating to construction workers and safety pros the location of hazards to avoid when near the area. The quick connect and release of the marker can be successfully completed from the ground and no ladder necessary was long as they are able to reach the object needing a marker or have possession of a reachers tool to hold the slaptagz to attach or remove to the intended pipe, line or coated wire.

### COPYRIGHT NOTICE

A portion of the disclosure of this patent document contains materials which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever

### BACKGROUND

### Field of the Invention

The present invention relates to employee health and safety at workplace. More particularly the current invention relates to method and tool to indicate the location of hazards at job sites.

### Description of the Related Art

Currently there are a number of solutions for marking hazards at job sites as well as marking important fixtures, sprinkler heads, for example stickers that must be placed near the exposed fixture, which requires the laborer to affix to a stationary pipe which may not be visible from the ground. Using a roll of caution tape affixing a section tying a knot, leaving a dangling portion, which may or may not be facing the direction of the crew searching for the sprinkler head. requiring a second climb up the ladder to remove the tape when the area no longer needs an indicator.

Another option is to create a banner using a sticker and attaching to a substrate then affixing a zip tie to the elevated location. this requires a ladder, a sticker, a flat substrate, a connection tool, a zip tie and a sharp object, Knife, or scissors when it needs to be removed. The diameter may vary, and random sizes of connection zip ties may be needed.

Some of these solutions attempt to mark or bring attention to the area hazards, but these solutions fail to meet the needs of the industry because each option required multiple ladder climbs to install and remove. Other solutions attempt to recognize that if the marker is not visible from all sides and entering crew may not see them close to the ceiling, but these solutions are similarly unable to meet the needs of the industry because in the event of a power outage, non-reflective materials do not offer visibility. Still other solutions seek to require attachment of markers or “S” Hooks but these solutions also fail to meet industry needs because every jobsite will not necessarily have all the standard size pipes or lines, so added accessories are needed. Even a zip tie connection requires an arial application and removal.

There are multiple hazard identification system that can be studied from prior art. For instance, a safety management system for worker bearing Chinese patent 1,011,42063B is issued to Chinese inventor. The patent discloses a safety management system for workers capable of finely managing the safety of the workers while flexibly coping with changes in situations on a work machine side and a worker side. [MEANS FOR SOLVING PROBLEMS] The safety of the workers is managed by safety management information in ID tags. At least a working area code indicating a working area allowed for a specific worker and a danger avoidance capacity code indicating the degree of the danger avoidance capacity of the worker are included in the safety management information.

The danger avoidance capacity indicated by the danger avoidance capacity code is determined in consideration of the skill of the worker uniformly qualified based on general qualification standards such as the experience in business and the number of times of receipt of safety education and lecture of the worker in the past and the specific degree of danger of working in the working area allowed for the worker.

An integrated hazardous substance tracking and compliance bearing U.S. Pat. No. 5,726,884A is issued to Alternative Systems Inc. The patent discloses an apparatus that provides an integrated approach for all management activities for hazardous substances used or generated at a facility, including form generation and compliance with the reporting requirements. The apparatus includes eight functional groupings and a database schema or coordinator that integrates these groupings and allows them to share and exchange relevant information. The functional groupings include a hazardous materials index grouping (chemical profiles, waste profiles, Material Safety Data Sheets, etc.), a hazardous materials management grouping (MSDS generation, process definition, materials transfers, etc.), a human resource management grouping (training, exposure limits, etc.), a hazardous commitment management grouping (compliance requirements and deadlines), an emergency management grouping (planning for and response to unscheduled releases), and a facility management grouping that can be used by or for response to a regulatory agency. Optionally, a hazardous waste management grouping (waste accumulations, Hazardous Waste Manifests, etc.) or a hazardous permit management grouping (permit approvals and renewals, etc.), or both, may be combined with all or different combinations of the other functional groupings to form an operating system. Optionally, the hazardous materials index grouping plus the hazardous materials management grouping plus the emergency management grouping plus the database schema may be combined with one of the other five functional groupings to form an operating system. Optionally, the hazardous materials index grouping plus the emergency management grouping plus the database schema may be combined with one of the other six functional groupings to form an operating system. The facility management grouping may act as a stand-alone module or may be integrated and used with combinations of the other groupings.

Another patent on Smart hazard detector drills bearing U.S. Pat. No. 9,672,728B2 is issued to Google LLC. The patent discloses systems and methods for initiating a drill by receiving an indication to start a drill. Initiating the drill also includes verifying that a remote device used to initiate the drill is within proximity of a device used to propagate the drill. Once proximity is verified, the drill is conducted.

Another apparatus and method for monitoring a detection area at a working means bearing a German patent 1,000,0287B4 is issued to Leuze lumiflex GmbH and Co KG. The patent discloses a device for monitoring a detection region (6) to a working medium with at least one camera (5) for the continuous detection of the detection region (6), with an evaluation unit, in which to distinguish safety-critical objects of non-safety-critical objects within at least one protection zone (7) within the detection range (6) (5) images generated are read in each case in the form of an array of pixels having different color values, wherein a weighted with weighting factors linear combination of the color values is formed in the evaluation for the individual pixels of the camera, said linear combinations with at least one in a threshold unit generated threshold value are evaluated, wherein the threshold value and the weighting factors are adjusted so that the safety-critical objects form regions of foreground pixels, each having a for example as “bright” formed first Binarisierungszustand, wherein the non-safety-critical objects form formed second Binarisierungszustand areas of background pixels, each having a for example as “dark”, where in the case that there is no safety-critical object located in the protection zone, so that background pixel in these are only present, one of the evaluation unit for working medium out switching output assumes a first switching state, whereby the operating means is taken into operation, and wherein penetration of at least one safety-critical object in the protection zone (7) in that a contiguous region of foreground pixels is created, so that the switching output assumes a second switching state, whereby the working medium is put out of operation via the evaluation unit.

Another patent on Device for the surveillance of the reach area in a work tool bearing European patent 1,544,535B1 is issued to Leuze lumiflex GmbH and Co KG. The patent discloses a 1.Device (1) for monitoring a detection region (2) at working means, comprising an illuminating unit (3), which emits light beams (6), for illumination of the detection region (2), a camera (4) for determination of three-dimensional images of the detection region (2) and an evaluating unit (10), by means of which at least one switching output (13), which is carried on the working means, is controlled so that the working means is placed in operation only if no object is located in the detection region (2), characterized in that the camera (4) comprises a matrix-shaped arrangement of receiving elements, the output signals of which are evaluated in the evaluating unit (10), wherein for each receiving element a distance value is determined from the light transit time of the light beams (6) emitted by the illuminating unit (3) and reflected back from the detection region (2), and that the sensor unit formed by the illuminating unit (3) and the camera (4) has a single-channel construction, wherein the sensor unit is self-protecting by a self-checking for faults, wherein in the case of a sensor unit operating in accordance with a pulse transit time method the light pulses emitted by the transmitter (5) are delayed by predetermined times for the fault self-checking and the thereby-changed distance values of the receiving elements are evaluated or in the case of a sensor unit operating according to the phase measuring method the phase of the amplitude modulation imposed on the light beams (6) is shifted for the fault self-checking and the thereby-changed distance values of the receiving elements are evaluated.

There are multiple solutions that have been presented in prior art. Within the last decade the advancement at employee health and safety is greatly stressed. Looking at the advanced and complex needs the current invention proposes an advance and smart device allowing to indicate the location of hazards at job site.

The current invention proposes a system, Slaptagz which is designed to be used from the ground and never would need a ladder for their attachment and removal. This prevents potential ladder fall accidents since it can be attached from the ground, as well as no shape objects are required for its removal. Time is also saved to apply a standard Slaptagz device since a variety of sizes are able to use the same unit. The assembly is designed to grip a ¾-inch pipe thru a 4-inch pipe and self-coil regardless of the diameter. The elastic plastic insert can be made either with metal or plastic bistable sheets.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

It is therefore the purpose of the invention to alleviate at least to some extent one or more of the aforementioned problems of the prior art and/or to provide the relevant public with a suitable alternative thereto having relative advantages.

The primary object of the invention is related to the provision of a device that allows connection from the ground which/that removes the risk of ladder falls and injuries. Furthermore, it would also be desirable to have a device that can be reused after use. Still further, it would be desirable to have a device that is a quick connect to save man hours/billable labor. The disclosed device and associated method advantageously fill these need and addresses the aforementioned deficiencies by providing a/an easy solution to connect a hazard banner, marker in elevated areas and quickly remove without the need to use a ladder without prior knowledge of the circumference or direction of the pipes needing marking. Diameter ordinarily comes into question if choosing to use an “S” type of attachment. A universal marker allowing use for all standard sizes, and without prior knowledge of diameter size of fixture/pipe/or shape of location would be beneficial for time saving and also storage of used products. previous attempts would result in a sticker product being removed and discarded.

The disclosed device as per its preferred embodiments is made up of the following components layered steel bands 5.5 inches long sealed within a 1½-inch-long plastic PVC and a connector ring open to add attachments, banners and markers to identify construction hazards. Hovering the device over a fixed pipe, you then slap down making the unit self-coil around whatever diameter is in front of it. These components are connected to form a row with the slap sign at the top, a middle connector chain to allow movement of indicator, and a bottom banner with desired message or logo once marker is no longer needed, the laborer using a reacher tool, grabs the chain and pulls down, releasing the unit from the pipe for repeat use or storage.

The device may also have one or more of the following: non reflective material for use in home, wider base to connect on non-construction applications, polyester covered material for antibacterial uses at a facility. Added connection ring spots to allow for additional tags and messages, such as an ending date. May be made triangular in shape to allow for a smaller gap application to a ceiling to temporarily mark an exit. Outdoor applications easily mark a gathering designation where the owners will not allow nails, hooks or anything deemed that will damage foliage, or structures. Similarly, the associated method may also include one or more of the following steps: A reflective connector that marks a safe path for trails that self-winds around a tree or bush but doesn't remain when the tree has outgrown the marker. A neoprene coated covering, a mesh covering, filtering of light, a leather, imitation leather, rubber coating, silicone coating, various substrates used for plumbing needs, recycled material, cloth material, and any man-made version that can be formed over the steel bands inside. an added option may include holes at both ends as well as 2 holes per side up to 10 holes per side for new attachments, lines, ropes, strings, chains, and ropes that fit within the diameter of the holes. logos and messages can be printed on 1 or both sides with pertinent information to the jobsite, safety locations, procedures or required reading material needed when notifying the masses. messages are not limited to a phrase. can also include graphs, maps, or anything the user finds of value. length may be adjusted for use including an added length 6 inches, 7 inches, 8 inches, 9 inches, 10 inches, 12 inches, up to 15 inches. This will depend entirely on the diameter of the permanent structure needing a marker. overlap of extra material may cause the Slaptagz not to release as intended so extra size length wouldn't be suggested for most applications.

The disclosed device is unique when compared with other known devices and solutions because it provides: (1) An easy and user friendly quick connect and release SlapTagz; (2) A Reflective band that can be visible during a power outage and (3) A safer method of identifying pipes, sprinklers and other construction, demolition items needing markers.

Similarly, the associated method is unique in that it: (1) Can be easily installed without a ladder); (2) Can be removed without a ladder; and (3) materials are waterproof allowing them to be applied and able to withstand all weather conditions including excessive heat and below freezing (4) No Adhesives are contained in the design so the temperature of the job site will not melt glue and release the marker, posing a potential safety hazard. Similarly, the disclosed method is unique when compared with other known processes and solutions in that it: (1) Is reusable for multiple applications and not a disposable item (2) reflective options for viewing from all directions near and any distance away from its placement; and (3) Visibly show a well-organized job site, with easily marked locations of hazards, key fixtures and chosen areas requiring highlight. An added option banner material has been crafted in a weight not requiring it to be printed on 2 sides. by printing on mesh, the design can be visible on 2 sides and intentionally facing a high traffic area, but visible from the opposite direction.

For safety reasons the device allows the connection to be made and removed without the use of sharp objects that can cause harm when used on a ladder, as in cutting a zip tie using a knife or scissor facing the ceiling.

The disclosed device is unique in that it is structurally different from other known devices or solutions. More specifically, the device is unique due to the presence of: (1) a self-winding steel band that self-coils when a slapping against the desired location. (2) a hanging chain that is made of stainless steel and is connected allowing the pulling motion not to affect the shape, length, or grommet placement for repeat use. and (3) length of the device allows for a range of sizes to be universally attached to. no need to get a variety of connection rings, ‘S’ Hooks that may or may not fit the pipe at the chosen connection. The 5½-inch version was designed to wrap in consecutive motion and self-adheres no matter the diameter.

Furthermore, the process associated with the aforementioned device is likewise unique. More specifically, the disclosed process owes its uniqueness to the fact that it: (1) By changing the length, width and adding an end connection hole to the device, it will have more uses than a specifically measured connection ring. reuse and recycling are an option (2) strength and height of the crew is not a factor. and (3) since it is water resistant and no adhesives are part of its connection functionality, temperature of the workspace is not a factor. For example, stickers placed on a pipe as a marker will not be effective in certain applications where the room temperature exceeds the level that the adhesive can tolerate, causing the label to become non adhesive and rendering the connection, unmade. the stainless-steel chain will not rust or discolor in job site conditions that may get wet.

The disclosure will now provide a more detailed and specific description that will refer to the accompanying drawings. The drawings and specific descriptions of the drawings, as well as any specific or alternative embodiments discussed, are intended to be read in conjunction with the entirety of this disclosure. The method and tool to indicate the location of hazards at job sites. may, however, be embodied in many different forms and should not be construed as being limited to the embodiments set forth herein; rather, these embodiments are provided by way of illustration only and so that this disclosure will be thorough, complete and fully convey understanding to those skilled in the art.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

FIG. 1 is a complete perspective view of the main assembly as per exemplary embodiments of the invention;

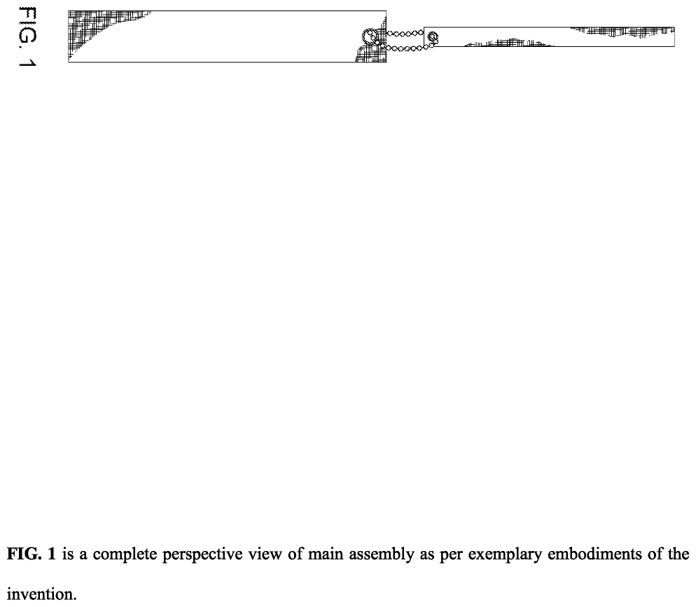

FIG. 2 is a complete perspective view of the device which is tapped onto a fixed horizontal structure or pipe per exemplary embodiments of the invention; and

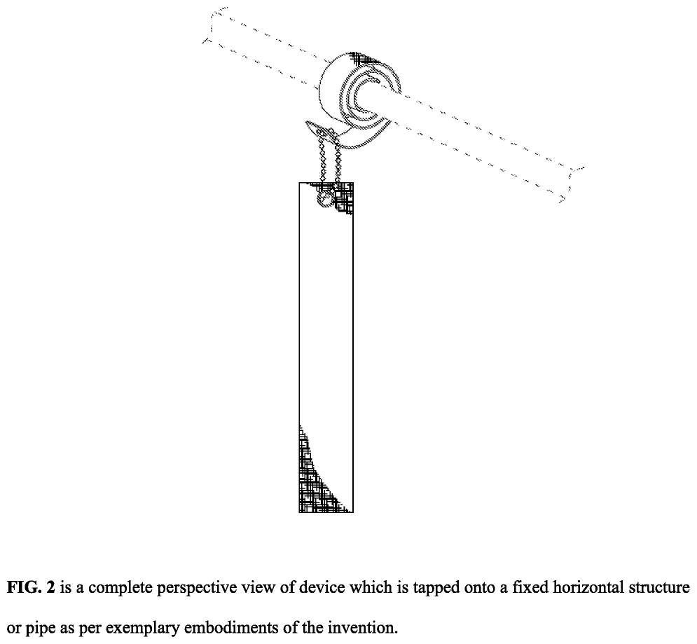

FIG. 3 is a complete perspective view of the device which is tapped onto a fixed vertical structure or pipe per exemplary embodiments of the invention.

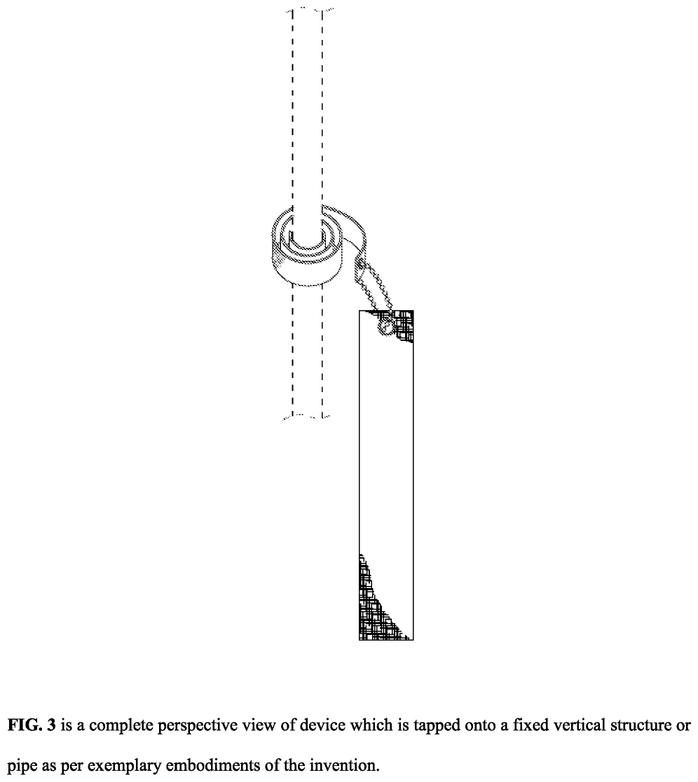

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, or manner.

The current invention in its preferred embodiment discloses an efficient system of identifying the location of hazards at job sites.

The present invention is directed to a method and tool to indicate the location of hazards at job sites. In its most complete form, the device is made up of the following components: a 5½ inch straight steel inner stacked band, rectangular shaped, encased in a row of plastic reflective material with a hole at the end and a 6 inch stainless steel bead chain, threaded through the hole, which connects to a banner that is visible below the marked area regardless of the direction and size of the pipe it attaches to.

When flat it appears as a rectangle, but when the device is tapped onto a fixed structure or pipe, the bistable inner steel band creates a coil around the object. gripping without extra assistance or ties.

These components are 5½ inches to accommodate differing diameters of pipes needing an indicator or marker. It should further be noted that: The Slaptagz do not require adhesives, special keys, release tools, scissors or sharp objects other than a gripper unit to pull down from the location when applicable, commonly referred to as a reacher tool.

The most complete form of performing the method associated with the disclosed device consists of the following steps: Place the Slaptagz in a reacher tool prong, elevate the unit and holder near desired marked location using a slapping motion, once the unit makes contact with the chosen surface, the self-winding motion will adhere the Slaptagz, chain and marker to the desired position. Release the grip of the reacher tool. It should further be noted that: In order to remove the unit from the location. Use a reacher tool positioned near the hanging chain, grip the loose chain, and pull in a downward motion. The Slaptagz will uncoil itself when force is used, and it can be placed onto the next surface as needed or switch banner message by opening the ball chain clasp. The stainless-steel bead chain can be opened and closed using its connector. snap into the closed position once correct message has been chosen. (indicator, safety notice, graphic, icon of choice)

The stainless-steel bead chain is added with a connector and can be removed from the Slaptagz unit although its function is to hold the message below as per requirements.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1: A hazard identification system comprising:
a 5½-inch straight steel inner stacked band;
rectangular shaped;
encased in a row of plastic reflective material with a hole at the end; and
a 6-inch stainless steel bead chain, threaded through the hole, which connects to a banner that is visible below the marked area regardless of the direction and size of the pipe

2: A hazard identification system appearing as a rectangle once flat, but when the device is tapped onto a fixed structure or pipe, the bistable inner steel band creates a coil around the object. gripping without extra assistance or ties.

3: The assembly does not require adhesives, special keys, release tools, scissors or sharp objects other than a gripper unit to pull down from the location when applicable, commonly referred to as a reachers tool.
